(19) United States
(12) Patent Application Publication
(10) Pub. No.: US 2016/0163338 A1
(43) Pub. Date: Jun. 9, 2016

(54) TUNNELING MAGNETORESISTIVE (TMR) SENSOR WITH A SOFT BIAS LAYER

(71) Applicant: HGST Netherlands B.V., Amsterdam (NL)

(72) Inventors: Kuok S. Ho, Emerald Hills, CA (US); Nian Ji, San Jose, CA (US); Quang Le, San Jose, CA (US); Ying Li, Shenzhen (CN); Simon H. Liao, Fremont, CA (US); Guangli Liu, Pleasanton, CA (US); Xiaoyong Liu, San Jose, CA (US); Suping Song, Fremont, CA (US); Shuxia Wang, San Jose, CA (US); Hualiang Yu, San Jose, CA (US)

(73) Assignee: HGST Netherlands B.V., Amsterdam (NL)

(21) Appl. No.: 14/559,856

(22) Filed: Dec. 3, 2014

(51) Int. Cl. G11B 5/39; G11B 5/127

(52) U.S. Cl. CPC G11B 5/3932; G11B 5/1272; G11B 5/3912

(57) ABSTRACT

An apparatus according to one embodiment includes a read sensor. The read sensor has an antiferromagnetic layer (AFM), a first antiparallel magnetic layer (AP1 ) positioned above the AFM layer in a first direction oriented along a media-facing surface and perpendicular to a track width direction, a non-magnetic layer positioned above the AP1 in the first direction, a second antiparallel magnetic layer (AP2) positioned above the non-magnetic layer in the first direction, a harrier layer positioned above the AP2 in the first direction, and a free layer positioned above the barrier layer in the first direction. A soft bias layer is positioned behind at least a portion of the free layer in an element height direction normal to the media-facing surface, the soft bias layer including a soft magnetic material configured to compensate for a magnetic coupling of the free layer with the AP2.

### FIELD OF THE INVENTION

The present invention relates to magnetic data storage devices, and more particularly, this invention relates to a magnetic data storage device that utilizes a tunneling magnetoresistive (TMR) sensor having a soft bias layer.

### BACKGROUND

The heart of a computer is a magnetic hard disk drive (HDD) which typically includes a rotating magnetic disk, a slider that has read and write heads, a suspension arm above the rotating disk and an actuator arm that swings the suspension arm to place the read and/or write heads over selected circular tracks on the rotating disk. The suspension arm biases the slider into contact with the surface of the disk when the disk is not rotating but, when the disk rotates, air is swirled by the rotating disk adjacent an air bearing surface (ABS) of the slider causing the slider to ride on an air bearing a slight distance from the surface of the rotating disk. When the slider rides on the air bearing the write and read heads are employed for writing magnetic impressions to and reading magnetic signal fields from the rotating disk. The read and write heads are connected to processing circuitry that operates according to a computer program to implement the writing and reading functions.

The volume of information processing in the information age is increasing rapidly. In particular, it is desired that HDDs be able to store more information in their limited area and volume. A technical approach to this desire is to increase the capacity by increasing the recording density of the HDD. To achieve higher recording density, further miniaturization of recording bits is effective, which in turn typically requires the design of smaller and smaller components.

The further miniaturization of the various components, however, presents its own set of challenges and obstacles. As areal density increases the read transducers need to be produced to be smaller and closer together, which results in cross-talk, interference, and/or degradation of performance of the various components, such as sensors, within the magnetic heads.

### SUMMARY

An apparatus according to one embodiment includes a read sensor. The read sensor has an antiferromagnetic layer (AFM), a first antiparallel magnetic layer (AP1) positioned above the AFM layer in a first direction oriented along a media-facing surface and perpendicular to a track width direction, a non-magnetic layer positioned above the AP1 in the first direction, a second antiparallel magnetic layer (AP2) positioned above the nonmagnetic layer in the first direction, a barrier layer positioned above the AP2 in the first direction, and a free layer positioned above the barrier layer in the first direction. A soft bias layer is positioned behind at least a portion of the free layer in an element height direction normal to the media-facing surface, the soft bias layer including a soft magnetic material configured to compensate for a magnetic coupling of the free layer with the AP2.

A method for forming a sensor according to one embodiment includes forming a first antiparallel magnetic layer (AP1), forming a second antiparallel magnetic layer (AP2) above the AP1 in a first direction oriented along a media-facing surface and perpendicular to a track width direction, forming a barrier layer above the AP2 in the first direction, and forming a free layer above the barrier layer in the first direction, wherein the AP1, the AP2, the free layer, and the barrier layer together form a read sensor. A soft bias layer is formed behind at least a portion of the free layer in an element height direction normal to the media-facing surface, the soft bias layer having a soft magnetic material configured to compensate for a magnetic coupling of the free layer with the AP2.

Any of these embodiments may be implemented in a magnetic data storage system such as a disk drive system, which may include a magnetic head, a drive mechanism for passing a magnetic medium (e.g., hard disk) over the magnetic head, and a controller electrically coupled to the magnetic head.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a simplified drawing of a magnetic recording disk drive system.

FIG. 2A is a schematic representation in section of a recording medium utilizing a longitudinal recording format.

FIG. 2B is a schematic representation of a conventional magnetic recording head and recording medium combination for longitudinal recording as in FIG. 2A.

FIG. 2C is a magnetic recording medium utilizing a perpendicular recording format.

FIG. 2D is a schematic representation of a recording head and recording medium combination for perpendicular recording on one side.

FIG. 2E is a schematic representation of a recording apparatus adapted for recording separately on both sides of the medium.

FIG. 3A is a cross-sectional view of one particular embodiment of a perpendicular magnetic head with helical coils.

FIG. 3B is a cross-sectional view of one particular embodiment of a piggyback magnetic head with helical coils.

FIG. 4A is a cross-sectional view of one particular embodiment of a perpendicular magnetic head with looped coils.

FIG. 4B is a cross-sectional view of one particular embodiment of a piggyback magnetic head with looped coils.

FIGS. 5A-5D show top views of various structures including a read sensor, according to several embodiments.

FIGS. 6A-6D show a cross-sectional side views of various structures including a read sensor, according to several embodiments.

FIG. 7 shows a plot of Hf versus RA for various read sensors, according to experimental results.

FIG. 8 shows effects of Hf on the magnetic field for various read sensors, according to experimental results.

FIG. 9 shows a schematic diagram of the effects of the bias field on the free layer magnetic moment, in one approach.

FIG. 10 shows a flowchart of a method according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as web as meanings understood by those skilled in the art and/or as defined in dictionaries, treatises, etc.

It must also be noted that, as used in specification and the appended claims, the singular forms “a,” “an” and “the” include plural referents unless otherwise specified.

The following description discloses several preferred embodiments of disk-based storage systems and/or related systems and methods, as well as operation and/or component parts thereof.

In one general embodiment, an apparatus includes a read sensor having an antiferromagnetic layer (AFM), a first antiparallel magnetic layer (AP1) positioned above the AFM layer in a first direction oriented along a media-facing surface and perpendicular to a track width direction, a non-magnetic layer positioned above the AP1 in the first direction, a second antiparallel magnetic layer (AP2) positioned above the non-magnetic layer in the first direction, a barrier layer positioned above the AP2 in the first direction and a free layer positioned above the barrier layer in the first direction. A soft bias layer is positioned behind at least a portion of the free layer in an element height direction normal to the media facing surface, the soft bias layer including a soft magnetic material configured to compensate for a magnetic coupling of the free layer with the AP2.

In another general embodiment, a method tier forming a sensor includes forming a first antiparallel magnetic layer (AP1), forming a second antiparallel magnetic layer (AP2) above the AP1 in a first direction oriented along a media-facing surface and perpendicular to a track width direction, forming a barrier layer above the AP2 in the first direction, and forming a free layer above the barrier layer in the first direction, wherein the AP1, the AP2, the free layer, and the barrier layer together form a read sensor. A soft bias layer is formed behind at least a portion of the free layer in an element height direction normal to the media-facing surface, the soft bias layer having a soft magnetic material configured to compensate for a magnetic coupling of the free layer with the AP2.

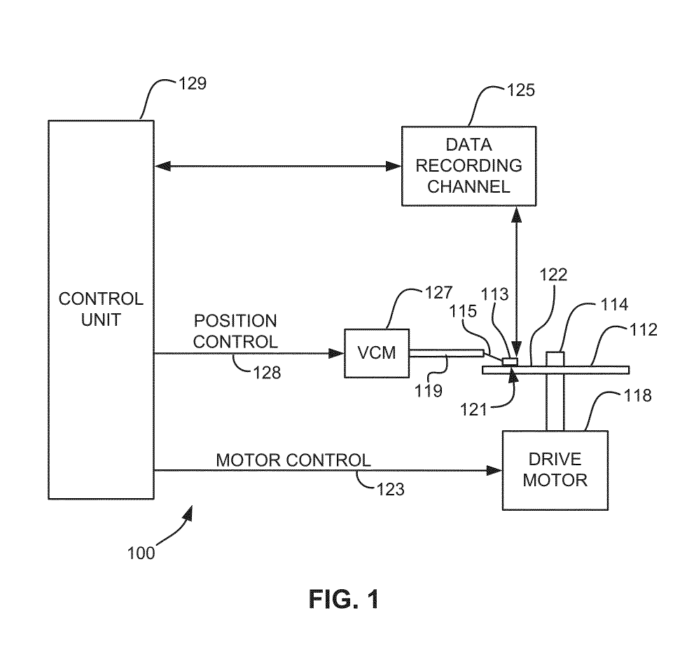

Referring now to FIG. 1, there is shown a disk drive 100 in accordance with one embodiment of the present invention. As shown in FIG. 1, at least one rotatable magnetic medium (e,g., magnetic disk) 112 is supported on a spindle 114 and rotated by a drive mechanism, which may include a disk drive motor 118. The disk drive motor 118 preferably passes the magnetic disk 112 over the magnetic read/write portions 121, described immediately below.

At least one slider 113 is positioned near the disk 112, each slider 113 supporting one or more magnetic read/write portions 121, e.g., a magnetic head according to any of the approaches described and/or suggested herein. As the disk rotates, slider 113 is moved radially in and out over disk surface 122 so that portions 121 may access different tracks of the disk where desired data are recorded and/or to be written. Each slider 113 is attached to an actuator arm 119 by means of a suspension 115. The suspension 115 provides a slight spring force which biases slider 113 against the disk surface 122. Each actuator arm 119 is attached to an actuator 127. The actuator 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of disk 112 generates an air bearing between slide 113 and disk surface 122 which exerts an upward force or lift on the slider. The air bearing thus counter-balances the slight spring force of suspension 115 and supports slider 113 off and slightly above the disk surface by a small, substantially constant spacing during normal operation. Note that in some embodiments, the slider 113 may slide along the disk surface 122.

The various components of the disk storage system are controlled in operation by control signals generated by controller 129, such as access control signals and internal clock signals. Typically, control unit 129 comprises logic control circuits, storage (e,g., memory), and a microprocessor. In a preferred approach, the control unit 129 is electrically coupled (e.g., via wire, cable, line, etc.) to the one or more magnetic read/write portions 121, for controlling operation thereof. The control unit 129 generates control signals to control various system operations such as drive motor control signals on line 123 and head position and seek control signals on line 128. The control signals on line 128 provide the desires current profiles to optimally move and position slider 113 to the desired data track on disk 112. Read and write signals are communicated to and from read/write portions 121 by way of recording channel 125.

The above description of a typical magnetic disk storage system, and the accompanying illustration of FIG. 1 is for representation purposes only. It should be apparent that disk storage systems may contain in a large number of disks and actuators, and each actuator may support a number of sliders.

An interface may also be provided for communication between the disk drive and a host (integral or external) to send and receive the data and for controlling the operation of the disk drive and communicating the status of the disk drive to the host, all as will be understood by those of skill in the art.

In a typical head, an inductive write portion includes a coil layer embedded in one or more insulation layers (insulation stack), the insulation stack being located between first and second pole piece layers. A gap is firmed between the first and second pole piece layers of the write portion by a gap layer at or near a media facing side of the head (sometimes referred to as an ABS in a disk drive). The pole piece layers may be connected at a back gap. Currents are conducted through the coil layer, which produce magnetic fields in the pole pieces. The magnetic fields fringe across the gap at the media facing side for the purpose of writing bits of magnetic field information in tracks on moving media, such as in circular tracks on a rotating magnetic disk.

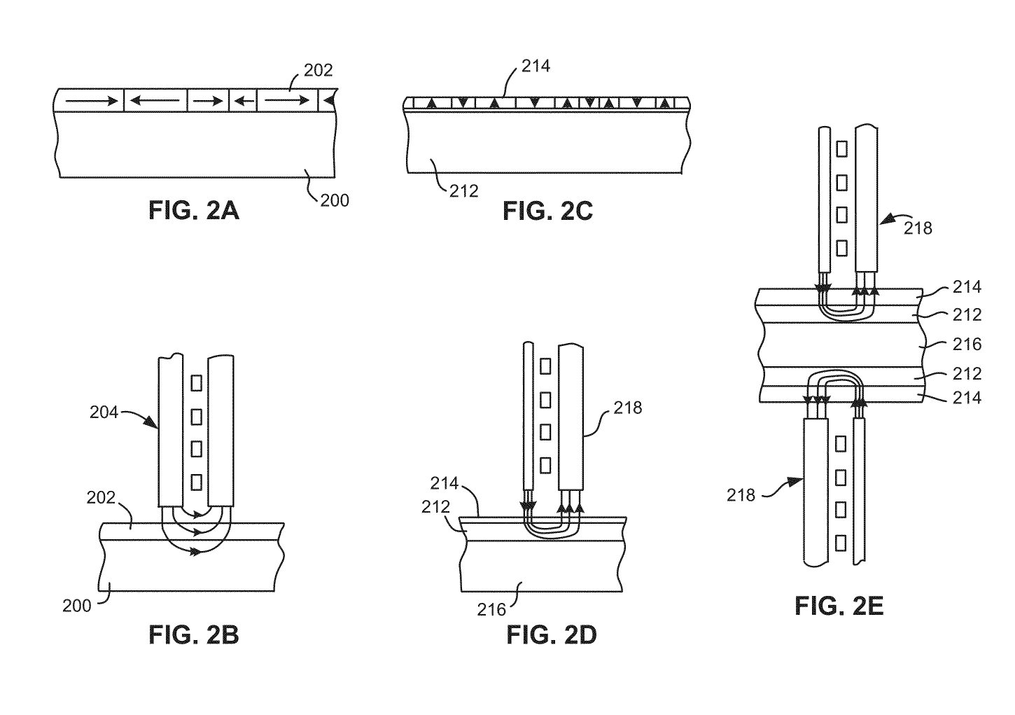

FIG. 2A illustrates, schematically, a conventional recording medium such as used with magnetic disc recording systems, such as that shown in FIG. 1. This medium is utilized for recording magnetic impulses in or parallel to the plane of the medium itself. The recording medium, a recording disc in this instance, comprises basically a supporting substrate 200 of a suitable nonmagnetic material such as glass, with an overlying coating 202 of a suitable and conventional magnetic layer.

FIG. 2B shows the operative relationship between a conventional recording/playback head 204, which may preferably be a thin film head, and a conventional recording medium, such as that of FIG. 2A.

FIG. 2C illustrates, schematically, the orientation of magnetic impulses substantially perpendicular to the surface of a recording medium as used with magnetic disc recording systems, such as that shown in FIG. 1. For such perpendicular recording the medium typically includes an under layer 212 of a material having a high magnetic permeability. This under layer 212 is then provided with an overlying coating 214 of magnetic material preferably having a high coercivity relative to the under layer 212.

FIG. 2D illustrates the operative relationship between a perpendicular head 218 and a recording medium. The recording medium illustrated in FIG. 2D includes both the high permeability under layer 212 and the overlying coating 214 of magnetic material described with respect to FIG. 2C above. However, both of these layers 212 and 214 are shown applied to a suitable substrate 216. Typically there is also an additional layer (not shown) called an “exchange-break” layer or “interlayer” between layers 212 and 214.

In this structure, the magnetic lines of flux extending between the poles of the perpendicular head 218 loop into and out of the overlying coating 214 of the recording medium with the high permeability under layer 212 of the recording medium causing the lines of flux to pass through the overlying coating 214 in a direction generally perpendicular to the surface of the medium to record information in the overlying coating 214 of magnetic material preferably having a high coercivity relative to the under layer 212 in the form of magnetic impulses having their axes of magnetization substantially perpendicular to the surface of the medium. The flux is channeled by the soft under layer 212 back to the return layer (P1) of the head 218.

FIG. 2E illustrates a similar structure in which the substrate 216 carries the layers 212 and 214 on each of its two opposed sides, with suitable recording heads 218 positioned adjacent the outer surface of the magnetic coating 214 on each side of the medium, allowing for recording on each side of the medium.

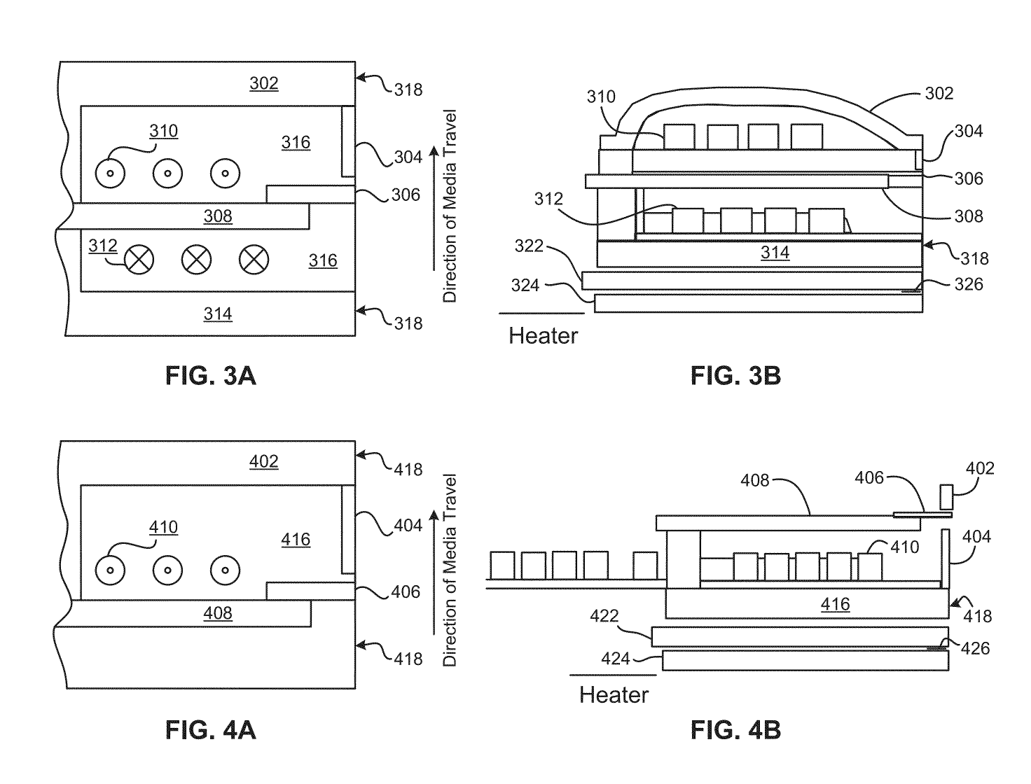

FIG. 3A is a cross-sectional view of a perpendicular magnetic head. In FIG. 3A, helical coils 310 and 312 are used to create magnetic flux in the stitch pole 308, which then delivers that flux to the main pole 306. Coils 310 indicate coils extending out from the page, while coils 312 indicate coils extending into the page. Stitch pole 308 may be recessed from the media facing side 318. Insulation 316 surrounds the coils and may provide support for some of the elements. The direction of the media travel, as indicated by the arrow to the right of the structure, moves the media past the leading shield 314 first, then past the stitch pole 308, main pole 306, trailing shield 304 which may be connected to the wrap around shield (not shown), and finally past the upper return pole 302. Each of these components may have a portion in contact with the media facing side 318. The media facing side 318 is indicated across the right side of the structure.

Perpendicular writing is achieved by forcing flux through the stitch pole 308 into the main pole 306 and then to the surface of the disk positioned towards the media facing side 318.

FIG. 3B illustrates a piggyback magnetic head having similar features to the head of FIG. 3A. Two shields 304, 314 flank the stitch pole 308 and main pole 306. Also sensor shields 322, 324 are shown. The sensor 326 is typically positioned between the sensor shields 322, 324.

FIG. 4A is a schematic diagram of one embodiment which uses looped coils 410, sometimes referred to as a pancake configuration, to provide flux to the stitch pole 408. The stitch pole then provides this flux to the main pole 406.1n this orientation, the lower return pole is optional. Insulation 416 surrounds the coils 410, and may provide support for the stitch pole 408 and main pole 406. The stitch pole may be recessed from the media facing side 418. The direction of the media travel, as indicated by the arrow to the right of the structure, moves the media past the stitch pole 408, main pole 406, trailing shield 404 which may be connected to the wrap around shield (not shown), and finally past the upper return pole 402 (all of which may or may not have a portion in contact with the media facing side 418). The media facing side 418 is indicated across the right side of the structure. The trailing shield 404 may be in contact with the main pole 406 in some embodiments.

FIG. 4B illustrates another type of piggyback magnetic head having similar features to the head of FIG. 4A including a looped coil 410, which wraps around to form a pancake coil. Also, sensor shields 422, 424 are shown. The sensor 426 is typically positioned between the sensor shields 422, 424.

In FIGS. 3B and 4B, an optional heater is shown away from the media facing side of the magnetic head. A heater (Heater) may also be included in the magnetic heads shown in FIGS. 3A and 4A. The position of this heater may vary based on design parameters such as where the protrusion is desired,coefficients of thermal expansion of the surrounding layers, etc.

Except as otherwise described herein, the various components of the structures of FIGS. 3A-4B may be of conventional materials and design, as would be understood by one skilled in the art

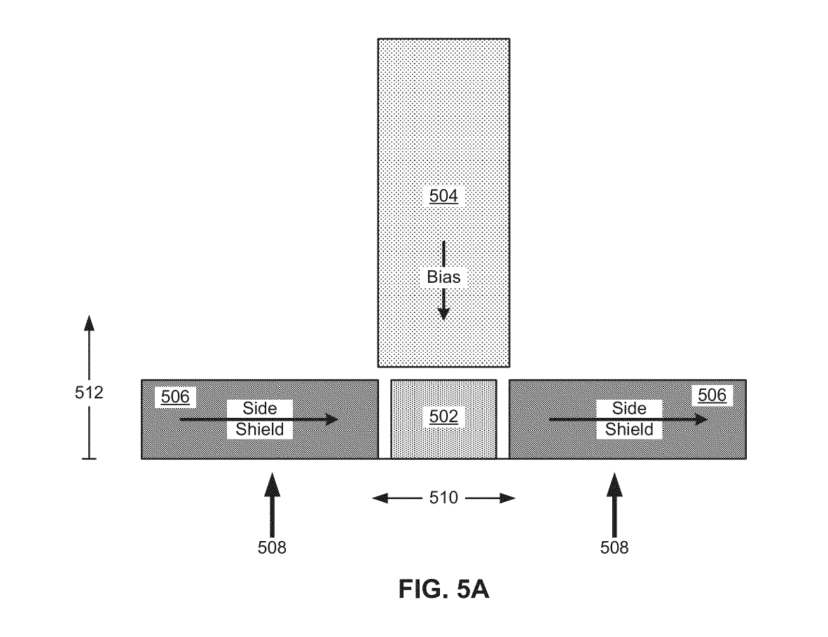

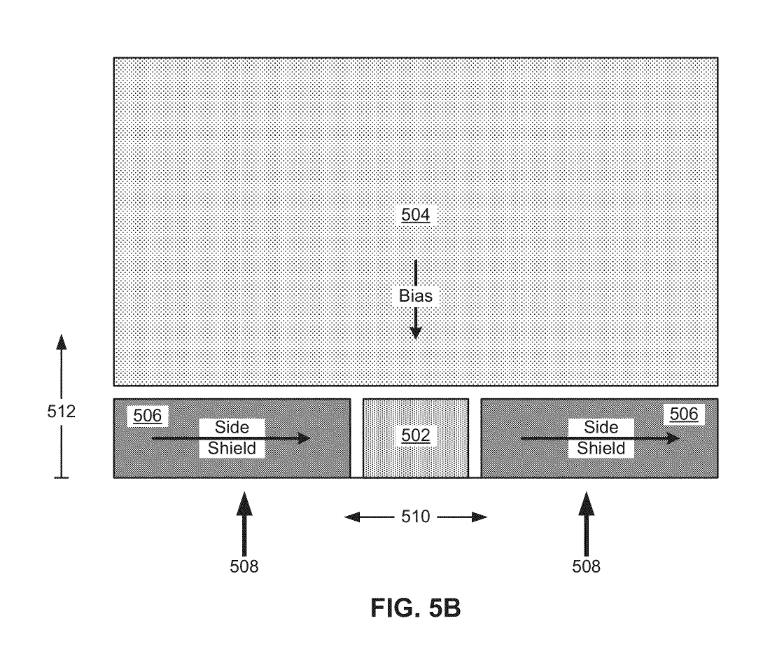

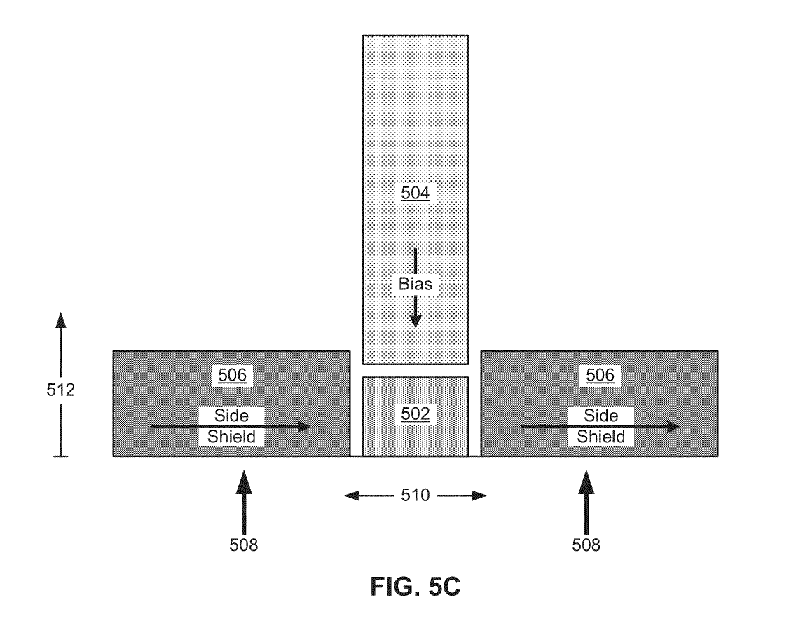

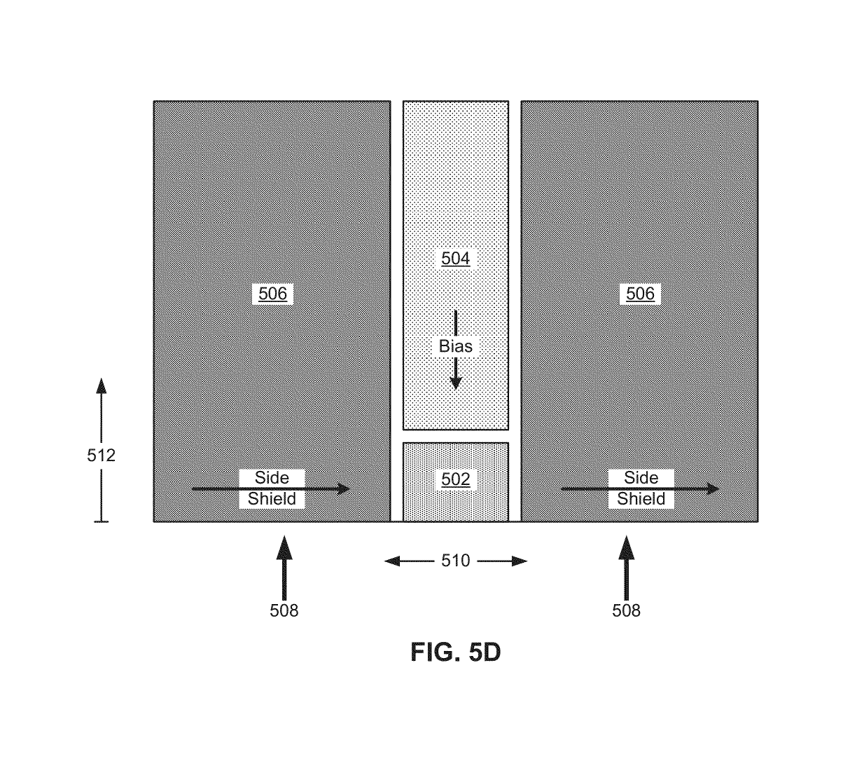

Referring to FIGS. 5A-5D, a magnetic head structure is shown according to various embodiments. Each magnetic head structure includes a read sensor 502 and a soft bias layer 504. In each of the magnetic head structures depicted, the soft bias layer 504 may have shape anisotropy that orients a magnetization thereof in a direction perpendicular to a media-facing surface 508 of the read sensor 502, as indicated by the arrow labeled “Bias.” According to another embodiment, a side shield 506 may be positioned on one or more sides of the read sensor 502 in a track width direction 510. The side shield 506 may have a magnetic orientation parallel to the media-facing surface 508 and perpendicular to the magnetization of the soft bias layer 504. The side shield 506 magnetization is indicated by the arrows positioned in each layer on either side of the read sensor 502 labeled “Side Shield.” Although not shown, in another embodiment, the magnetization of the side shield 506 may be oriented in a direction opposite to that shown in FIGS. 5A-5D.

The side shield 506 may comprise any suitable material known in the art, such as soft magnetic materials, hard magnetic materials, composite magnetic materials (multiple magnetic layers with non-magnetic layer(s) interspersed therein), etc., such as CoCrPt, CoFe, CoCrNb, NiFe, etc.

The soft bias layer 504 may comprise any suitable soft magnetic material(s) known in the art, such as Nife, CoFe, etc. In other embodiments, the soft bias layer 504 may comprise a hard magnetic material, and/or a soft/hard magnetic composite with one or more soft magnetic layers stacked with one or more hard magnetic layers, as would be understood by one of skill in the art.

FIGS. 5A and 5B are representative of structures which may be achieved by defining the track width prior to definition of the stripe height. In contrast, FIGS. 5C and 5D are representative of structures which may be achieved by defining the stripe height prior to definition of the track width.

As shown in FIG. 5A, in one embodiment, the soft bias layer 504 may have a length in an element height direction 512 which is at least twice a width in the track width direction 510 to form the shape anisotropy, as described above. In other embodiments, the length-to-width ratio may be 1:1, 3:2, 3:1, 5:1, 10:1, or greater, depending on a desired biasing effect, manufacturing limitations and/or efficiencies, positioning of other components of the read sensor and/or magnetic head, etc.

In one particular embodiment, as shown in FIG. 5A, the width of the soft bias layer 504 may be greater than the width of the read sensor 502 in the track width direction 510. Of course, the width of the read sensor 502 in the track width direction 510 may be greater than, about equal, or less than the width of the soft bias layer 504 in various embodiments, depending on a desired biasing effect, manufacturing limitations and/or efficiencies, positioning of other components of the read sensor and/or magnetic head, etc.

As shown in FIG. 5B, in one embodiment, the soft bias layer 504 may extend to about an extent of the side shield 506 on one or both sides of the read sensor 502 in the track width direction 510. The extent of the side shield 506 may correspond with a farthest edge of the side shield 506 in the track width direction 510 on one or both sides of the read sensor 502, and may correspond with an edge of the read sensor 502 when no side shield 506 is positioned on a particular side of the read sensor 502.

As shown in FIG. 5C, in one embodiment, the side shield may extend beyond a back edge of the read sensor 502 in the element height direction. The back edge of the read sensor 502 is an edge of the read sensor 502 opposite the media-facing surface 508 of the read sensor 502. Furthermore, in another embodiment, the width of the soft bias layer 504 may be substantially equal to the width of the read sensor 502 in the track width direction 510.

As shown in FIG. 5D, in one embodiment, the side shield 506 may extend to about an extent of the soft bias layer 504 in the element height direction. Furthermore, in another embodiment, the width of the soft bias layer 504 may be substantially equal to the width of the read sensor 502 in the track width direction 510. Of course, in other embodiments, the width of the soft bias layer 504 may be less than, equal, or greater than the width of the read sensor 502 in the track width direction 510, depending on a desired biasing effect, manufacturing limitations and/or efficiencies, positioning of other components of the read sensor and/or magnetic head, etc.

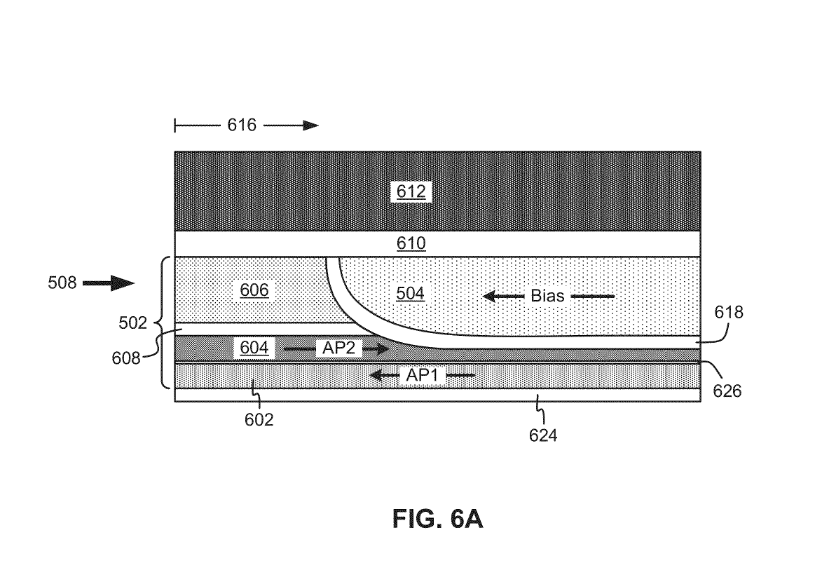

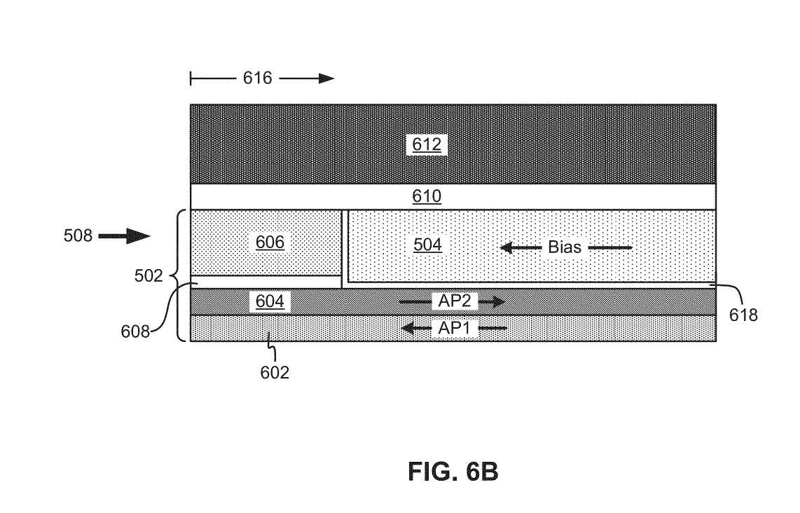

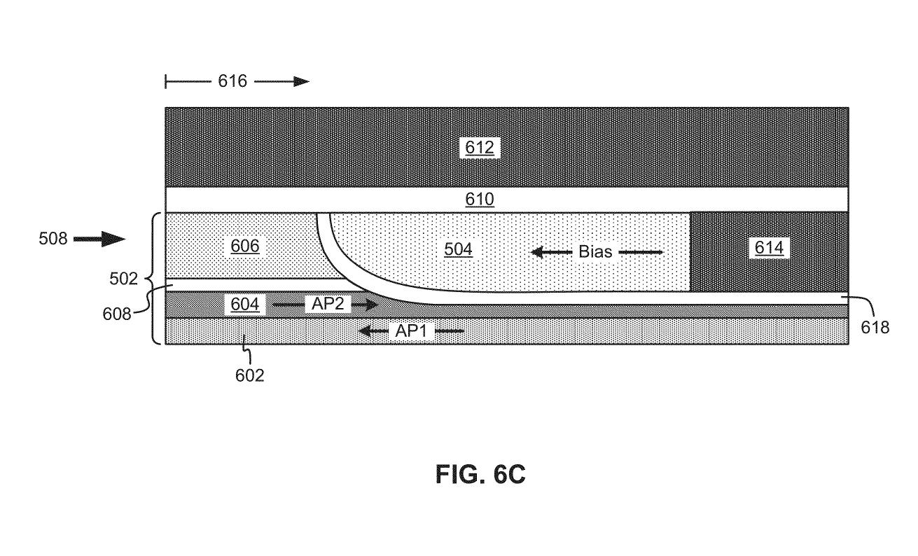

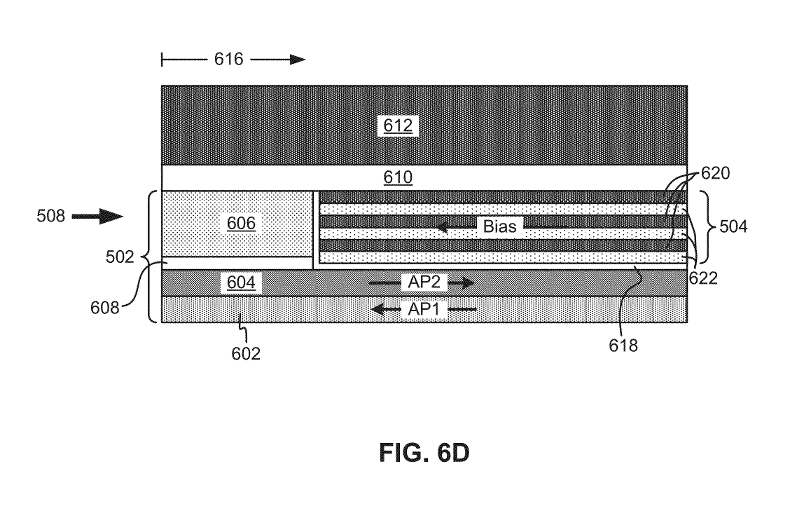

As shown in FIGS. 6A-6D, cross-sectional side views (throat views) of structures are shown according to various embodiments. Each structure may include a read sensor 502 and a soft bias layer 504. The read sensor 502 may include, when viewed from a cross-section with a media-facing surface 508 oriented to one side, a first antiparallel magnetic layer (AP1) 602, a second antiparallel magnetic layer (AP2) 604 positioned above the AP1 602 in a first direction oriented along the media-facing surface 508 and perpendicular to a track width direction, a barrier layer 608 positioned above the AP2 604 in the first direction, and a free layer 606 positioned above the barrier layer 608 in the first direction. In one embodiment, the read sensor 502 may be a tunneling magnetoresistive (TMR) read sensor, or some other suitable read sensor known in the art.

The free layer 606 has a magnetization that is oriented parallel with a media-facing surface 508 of the read sensor 502 and parallel with a plane of deposition of the free layer 606, such that it points either into the plane of the paper or out from the plane of the paper. The magnetization of the free layer 606 may be affected by magnetic fields external to the structure, such as from a magnetic medium having data stored thereon.

The AP1 602 has magnetization that is oriented antiparallel with the magnetization of the AP2 604, as indicated by the arrows labeled “AP1 ” and “AP2 ” in FIGS. 6A-6D, according to some embodiments. Although not shown in FIGS. 6A-6D, the magnetization of the AP1 602 and the AP2 604 may be reversed (opposite) to that shown in FIGS. 6A-6D according to other embodiments. Furthermore, the soft bias layer 504 has magnetization that is oriented perpendicular to the media-facing surface 508 of the read sensor 502, as indicated by the arrow labeled “Bias.”

In these embodiments, the magnetic moment of the soft bias layer 504 may be selected to compensate for the magnetic coupling of the free layer 606 with the AP2 604, In order to accomplish this compensation, material, thickness, and/or height of the soft bias layer 504 may be adjusted at the back edge of the free layer 606, as would be understood by one of skill in the art upon reading the present descriptions. The back edge of the free layer 606 is an edge of the free layer 606 opposite the media-facing surface 508 of the free layer 606.

Also, as shown in FIG. 6A (but omitted from FIGS. 6B-6D for simplicity sake), the structures may include an antiferromagnetic (AFM) layer 624 positioned below the AP1 602 that is exchange coupled with the AP1 602. This exchange coupling strongly pins the magnetization of the AP1 602 in a first direction that is perpendicular with the media facing surface 508. Anti-parallel coupling between the AP1 602 and the AP2 604 pins the magnetization of the AP2 604 in a direction opposite to that of the AP1 602. The AFM layer 624 may comprise any suitable material known in the art, such as IrMn, FeMn, PtMn, etc., among others.

The AP2 604 may be separated from the AP1 602 by an antiparallel coupling (APC) layer 626, a thickness of this APC layer 626 being chosen such that an antiparallel coupling is established between the AP1 602 and the AP2 604 so that the magnetization directions of AP1 602 and AP2 604 are aligned parallel and opposite to each other. The APC layer 626 may comprise any suitable material known in the art, such as non-magnetic metals, Ru, Ta, etc.

In further embodiments, the barrier layer 608 may comprise any suitable material known in the art, such as MgO, AlO, alumina, etc.

The soft bias layer 504 may be positioned behind at least a portion of the free layer 606 in an element height direction 616. The soft bias layer 504 may comprise any suitable soft magnetic material known in the art, such as nickel alloys such as Nife, cobalt alloys such as CoFe, etc. The magnetic moment of the soft bias layer 504 may be in a direction antiparallel to and/or against the magnetic moment of the AP2 604, in certain embodiments.

Also, in each magnetic head structure, the AP1 602 may extend below the AP2 604 and the soft bias layer 504 in the element height direction 616. Furthermore, in some approaches, at least a portion of the AP2 604 may extend below the soft bias layer 504 in the element height direction 616. According to various embodiments, all, some, or none of the AP2 604 may extend below the soft bias layer 504 in the element height direction 616 beyond a closest point of the soft bias layer 504 to the media-facing surface 508.

Furthermore, in some embodiments, the magnetic head structure may include a spacer layer 610 positioned above the free layer 606 and the soft bias layer 504 in the first direction, and, in some approaches, an upper shield 612 positioned above the spacer layer 610 in the first direction.

Any suitable materials known in the art may be used for the AP1 602, the AP2 604, the free layer 606, the barrier layer 608, the spacer layer 610, and/or the upper shield 612. Furthermore, different embodiments may utilize different materials in order to provide certain benefits of such materials, as would be understood by one of skill in the art.

As shown in FIG. 6A, the soft bias layer 504 may be positioned substantially behind the free layer 606 in the element height direction 616, thereby providing a maximum effect on the magnetic moment of the free layer 606. In this embodiment, an upper portion of the AP2 604 may be removed behind the extent of the free layer 606 in the element height direction 616, thereby allowing an insulating layer 618 to be positioned between the soft bias layer 504 and any or all of the barrier layer 608, the free layer 606, and the AP2 604. The insulating layer 618 may comprise any suitable electrically insulating material known in the art, such as alumina, MgO, SiO₂, ZrN, etc. In this embodiment, the back edge of the read sensor 502 is gradually sloped to be longer in the element height direction 616 closer to the AP1 602 than it is closer to the spacer layer 619.

In a next embodiment, as shown in FIG. 6B, the soft bias layer 504 is still positioned substantially behind the free layer 606 in the element height direction 616, thereby providing a maximum effect on the magnetic moment of the free layer 606; however, the back edge of the read sensor 502 is squared off and/or abrupt, thereby providing a straight back edge to the read sensor above the AP2 604. This allows for the soft bias layer 504 to be formed close to the back edge, with a very thin insulating layer 618 formed therebetween, such as via atomic layer deposition (ALD). The insulating layer 618 may comprise any suitable electrically insulating material known in the art, such as alumina, MgO, SiO₂, ZrN, etc. In this embodiment, all or substantially all of the AP2 604 remains below the free layer 606 and the soft bias layer 504.

In another embodiment, as shown in FIG. 6C, the magnetic head structure may include a hard bias layer 614, at least a portion thereof being positioned behind the soft bias layer 504 in the element height direction 616. The hard bias layer 614 may comprise any suitable hard magnetic material known in the art, and may be configured to provide unidirectional anisotropy to the soft bias layer 504. In one embodiment, at least a portion of the hard bias layer 614 may he in direct contact with a back edge of the soft bias layer 504, as shown in FIG. 6C. In another embodiment, at least a portion of the hard bias layer 614 may extend beyond sides of the read sensor 502 and the soft bias layer 504 in a track width direction (not shown).

According to more embodiments, an insulating layer 618 may be positioned between the soft bias layer 504 and any and/or all of: the barrier layer 608, the free layer 606, and/or the AP2 604. The insulating layer 618 may comprise any suitable electrically insulating material known in the art, such as alumina, MgO, SiO₂, ZrN, etc.

In yet another embodiment, as shown in FIG. 6D, the soft bias layer 504 may comprise a hard/soft magnetic composite material, which may include one or more (such as a plurality of) hard magnetic material layers 620 stacked with one or more (such as a plurality of) soft magnetic material layers 622. In the embodiment shown, three soft magnetic material layers 622 are interspersed between three hard magnetic material layers 620; however, any number of each of the hard/soft magnetic material layers may be used as determined by one of skill in the art to produce a desired biasing effect.

Although it is not shown in any of the figures, it is noted that the spacer layer 610 may be configured such that it separates the free layer 606 and bias layer 504 from the upper shield 612, but such that it does not extend laterally over the side shield 506 (as shown in FIGS. 5A-5D). This magnetically decouples the soft bias layer 504 from the upper shield 612, while allowing magnetic coupling between the side shield 506 and the upper shield 612.

In a further embodiment, a magnetic data storage system, such as that shown in FIG. 1, may include at least one magnetic head comprising the read sensor as recited in according to any embodiment herein, a magnetic medium, a drive mechanism for passing the magnetic medium over the at least one magnetic head, and a controller electrically coupled to the at least one magnetic head for controlling operation of the at least one magnetic head.

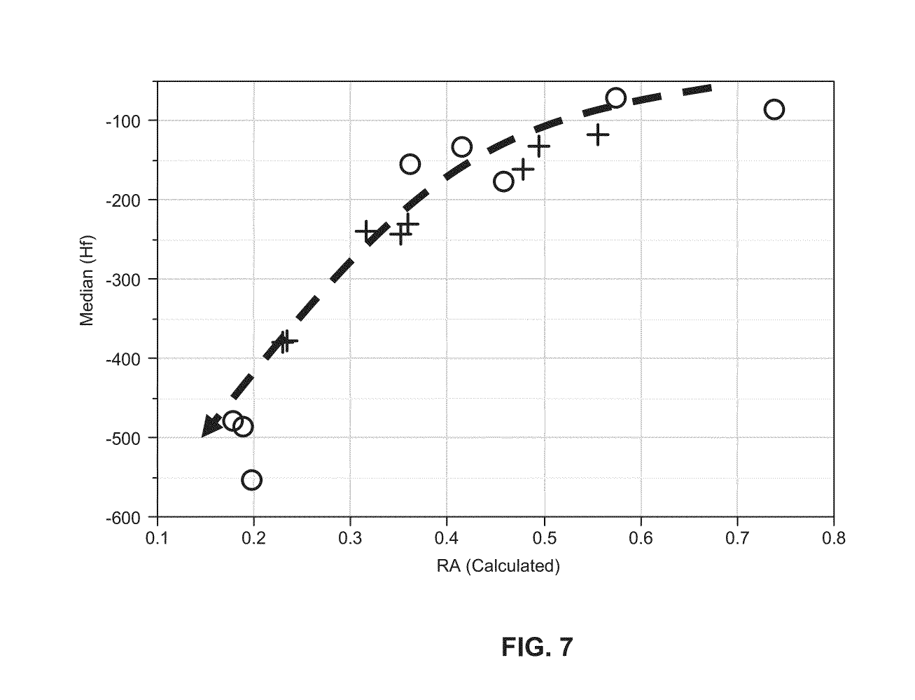

For a conventional TMR read head with an area resistance (RA) below 0.5, the orange-peel coupling field (Hf) may be on the order of several hundred Oersted (Oe), which is a dominating force for the free layer along the stripe height (SH) direction and comparable to a typical longitudinal bias field in magnitude. As a consequence, at a zero external field, the free layer is not sufficiently biased along the track width direction, resulting in movement of the bias point. In other words, with reference to FIGS. 6A-6D, the orange peel coupling field (Hf) resulting from the AP2 604 causes the magnetization of the free layer 606 to be canted from its desired direction parallel with the media facing surface 508. This trend may be seen in the plot shown in FIG. 7, according to experiments conducted on various read sensors.

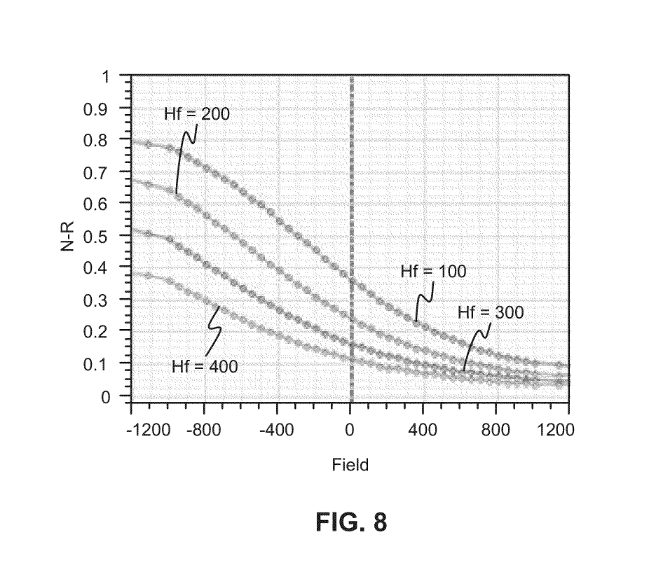

A simple Stoner-Wolfarth model calculation shows that with increasing Hf, the TMR sensor suffers substantially from Asymmetry/Utilization loss due to a bias point shift resulting from uncompensated Hf. This trend may be seen in the plot shown in FIG. 8, according to experiments conducted on various read sensors.

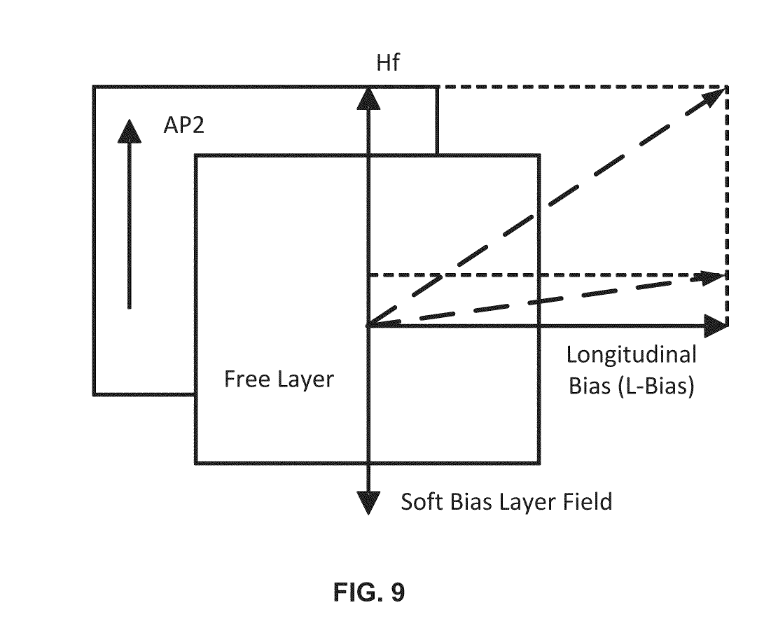

Now referring to FIG. 9, effects from usage of the soft bias layer may be visualized on the magnetic field of the free layer. The soft bias layer is positioned at the back edge of the free layer and has a biasing magnetic moment that is opposite to the magnetic moment direction of the AP2. Therefore, the soft bias layer introduces a bias field on the free layer along the transverse direction against the Hf direction, which serves the purpose of adjusting the bias point. This improves both the asymmetry mean and utilization factor of the read sensor.

According to experiments conducted on various read sensors, according to one embodiment, the soft bias layer magnetic field may be set to be about equal to the Hf.

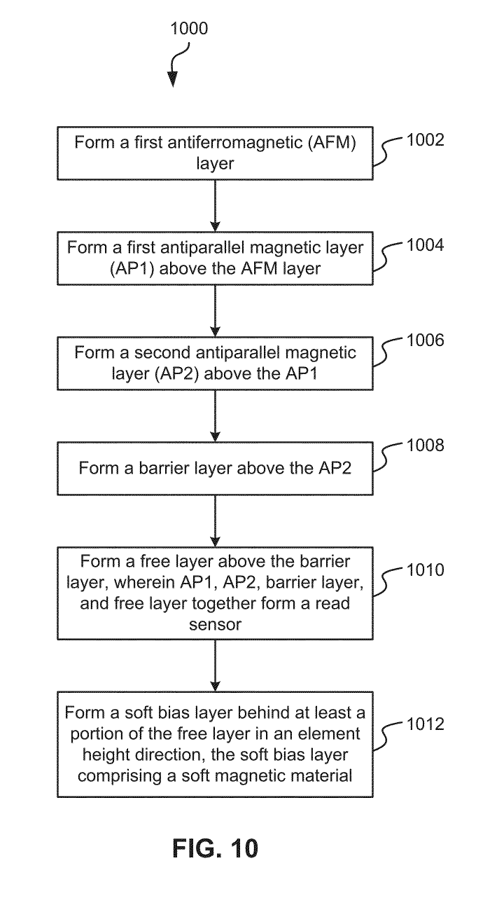

FIG. 10 shows a method 1000 for forming a read sensor, such as for use in a magnetic head, in accordance with one embodiment. As an option, the present method 1000 may be implemented to construct structures such as those shown in FIGS. 1-9. Of course, however, this method 1000 and others presented herein may be used to form magnetic structures for a wide variety of devices and/or purposes which may or may not be related to magnetic recording. Further, the methods presented herein may be carried out in any desired environment. It should also be noted that any aforementioned features may be used in any of the embodiments described in accordance with the various methods.

In operation 1002, a first antiferromagnetic layer (AFM) is formed, such as above a lower shield, a substrate, or some other suitable layer known in the art. The AFM may comprise any suitable material known in the art, such as IrMn, FeMn, PtMn, etc., among others. Furthermore, the AFM may be formed via any formation technique known in the art, such as sputtering, plating, atomic layer deposition (ALD), etc.

In operation 1004, a first antiparallel magnetic layer (AP1) is formed, such as above the AFM layer, a lower shield, a substrate, or some other suitable layer known in the art, in a first direction oriented along a media-facing surface and perpendicular to a track width direction. The AP1 may comprise any suitable material known in the art, such as CoFe, NiFe, CoCrPt, among others, or some combination of suitable materials. Furthermore, the AP1 may be formed via any formation technique known in the art, such as sputtering, plating, atomic layer deposition (ALD), etc.

In operation 1006, a second antiparallel magnetic layer (AP2) is formed above the AP1 in the first direction. The AP2 may comprise any suitable material known in the art, such as CoFe, NiFe, CoCrPt, among others, or some combination of suitable materials, and may comprise the same material as the AP1 or some other material. Furthermore, the AP2 may be formed via any formation technique known in the art, such as sputtering, plating, atomic layer deposition (ALD), etc. It should be noted that the AP2 may be separated from the AP1 by a thin layer of a non-magnetic material, the thickness of this layer being chosen such that an antiparallel coupling is established between the AP1 and the AP2 so that the magnetization directions of AP1 and AP2 are aligned parallel and opposite to each other. This non-magnetic material may comprise any suitable material known in the art, such as non-magnetic metals, Ru, Ta, etc.

In operation 1008, a barrier layer is formed above the AP2 in the first direction. The barrier layer may comprise any suitable material known in the art, such as MgO, AlO), alumina, etc.

In operation 1010, a free layer is formed above the barrier layer in the first direction. The free layer may comprise any suitable material known in the art (such as CoFe, CoFeB, NiFe, alloys thereof, etc.) or some combination of suitable materials known in the art and may be formed via any formation technique known in the art, such as sputtering, plating, ALD), etc. The AP1, the AP2, the barrier layer, and the free layer together form a read sensor.

In operation 1012, a soft bias layer is formed behind at least a portion of the free layer in the element height direction. The soft bias layer comprises a soft magnetic material of a type known in the art, such as NiFe, NiFeCo, CoFe, etc., or some combination of suitable materials know in the art. The soft bias layer may be formed via any formation technique known in the art, such as sputtering, plating, ALD, etc.

In one embodiment, the soft magnetic material may be chosen to correspond to the magnetic moment of the AP2. For example, for a range of between about 1 T and about 1.4 T, NiFe may be chosen. For a range of between about 1.4 T and about 2.0 T, NiFeCo may be chosen. Furthermore, for a range of between about 2.0 T and 2.4 T, CoFe may be chosen. Of course, other soft magnetic materials may be chosen to substantially cancel out the Hf to the free layer, in more approaches.

In each embodiment, the magnetic moment of the soft bias layer may be selected to compensate for the magnetic coupling of the free layer with the AP2. In order to accomplish this compensation, material, thickness, and/or height of the soft bias layer may be adjusted at the back edge of the free layer, as would be understood by one of skill in the art upon reading the present descriptions.

In a further embodiment, a hard bias layer may be formed, at least a portion thereof being formed behind the soft bias layer in the element height direction. The hard bias layer may comprise a hard magnetic material (of a type known in the art) configured to provide unidirectional anisotropy to the soft bias layer, and may be formed via any formation technique known in the art, such as sputtering, plating, ALD, etc. In a further embodiment, at least a portion of the hard bias layer may be in direct contact with a back edge of the soft bias layer, and at least a portion of the hard bias layer may extend at least to sides of the read sensor and the soft bias layer in a track width direction.

In another embodiment, method 1000 may include forming a soft side shield or hard magnet (HM) on one or more sides of the read sensor in a track width direction. In this embodiment, the soft bias layer may extend to at least one of an extent of the side shield on both sides of the read sensor in the track width direction, and/or beyond a back edge of the read sensor in the element height direction.

When the soft bias layer extends beyond the back edge of the read sensor in the element height direction, and the width of the soft bias layer is not greater than a width of the reader sensor, the side shield may also extend to about an extent of the soft bias layer in the element height direction.

In another approach, the soft bias layer may have shape anisotropy in a direction perpendicular to a media-facing surface of the read sensor (such as an ABS) that is achieved by forming the soft bias layer to have a length in the element height direction which is at least twice a width in a track width direction to form the shape anisotropy. In more embodiments, the length may be about three times the width, four times the width, five times the width, or more. Also, the width of the soft bias layer may be greater than or equal to a width of the read sensor in the track width direction.

In yet another approach, the AP1 may extend below the AP2 and the soft bias layer in the element height direction. In a further approach, at least a portion of the AP2 may extend below the soft bias layer in the element height direction.

The method 1000 may also include forming a spacer layer above the free layer and the soft bias layer in the first direction and/or forming an upper shield above the spacer layer in the first direction. The upper shield may be electrically isolated from the soft bias layer by the spacer layer or some other layer suitable for such a purpose. The spacer layer may comprise any suitable material known in the art, such as Ru, Ta₂O₅, etc., and may be formed using any formation technique known in the art. Also, the upper shield may comprise any suitable material known in the art, such as CoFe, NiFe, etc., and may be formed using any formation technique known in the art.

In another embodiment, method 1000 may also include forming an insulating layer between the soft bias layer and one, several, or all of: the barrier layer, the free layer, and the AP2. The insulating layer may comprise any suitable material known in the art, such as alumina, MgO, SiO₂, etc., and may be formed using any formation technique known in the art.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed:

1. An apparatus, comprising:
a read sensor, comprising:
an antiferromagnetic layer (AFM);
a first antiparallel magnetic layer (AP1) positioned above the AFM layer in a first direction oriented along a media-facing surface and perpendicular to a track width direction;
a non-magnetic layer positioned above the AP1 in the first direction;
a second antiparallel magnetic layer (AP2) positioned above the non-magnetic layer in the first direction;
a barrier layer positioned above the AP2 in the first direction; and
a free layer positioned above the barrier layer in the first direction; and
a soft bias layer positioned behind at least a portion of the free layer in an element height direction normal to the media-facing surface, the soft bias layer comprising a soft magnetic material configured to compensate for a magnetic coupling of the free layer with the AP2.

2. The apparatus as recited in claim 1, further comprising a hard bias layer, at least a portion thereof being positioned behind the soft bias layer in the element height direction, the hard bias layer comprising a hard magnetic material configured to provide unidirectional anisotropy to the soft bias layer.

3. The apparatus as recited in claim 2, wherein at least a portion of the hard bias layer is in direct contact with a back edge of the soft bias layer.

4. The apparatus as recited in claim 2, wherein at least a portion of the hard bias layer extends beyond sides of the read sensor and the soft bias layer in a track width direction.

5. The apparatus as recited in claim 1, further comprising a side shield positioned on one or more sides of the read sensor in a track width direction.

6. The apparatus as recited in claim 5, wherein the soft bias layer extends to about an extent of the side shield on both sides of the read sensor in the track width direction.

7. The apparatus as recited in claim 5, wherein the side shield extends beyond a back edge of the read sensor in the element height direction.

8. The apparatus as recited in claim 7, wherein the side shield extends to about an extent of the soft bias layer in the element height direction.

9. The apparatus as recited in claim 1, wherein the soft bias layer has shape anisotropy in a direction perpendicular to the media-facing surface of the read sensor.

10. The apparatus as recited in claim 9, wherein the soft bias layer has a length in the element height direction which is at least twice a width in a track width direction to form the shape anisotropy.

11. The apparatus as recited in claim 10, wherein the width of the soft bias layer is greater than a width of the read sensor in the track width direction.

12. The apparatus as recited in claim 10, wherein the width of the soft bias layer is substantially equal to a width of the read sensor in the track width direction.

13. The apparatus as recited in claim 1, wherein the AP1 extends below the AP2 and the soft bias layer in the element height direction, and wherein at least a portion of the AP2 extends below the soft bias layer in the element height direction.

14. The apparatus as recited in claim 1, further comprising:
a spacer layer positioned above the free layer and the soft bias layer in the first direction;
an upper shield positioned above the spacer layer in the first direction; and
an insulating layer positioned between the soft bias layer and all of: the barrier layer, the free layer, and the AP2.

15. The apparatus as recited in claim 1, wherein a material, thickness, and/or height of the soft bias layer may be adjusted at a back edge of the free layer to compensate for the magnetic coupling of the free layer with the AP2, the back edge being an edge of the free layer opposite the media-facing surface of the free layer.

16. A magnetic data storage system, comprising:
at least one magnetic head comprising the apparatus as recited in claim 1;
a magnetic medium;
a drive mechanism for passing the magnetic medium over the at least one magnetic head; and
a controller electrically coupled to the at least one magnetic head for controlling operation of the at least one magnetic head.

17. A method for forming a sensor, the method comprising:
forming a first antiparallel magnetic layer (AP1);
forming a second antiparallel magnetic layer (AP2) above the AP1 in a first direction oriented along a media-facing surface and perpendicular to a track width direction;
forming a barrier layer above the AP2 in the first direction; and
forming a free layer above the barrier layer in the first direction, wherein the AP1, the AP2, the free layer, and the barrier layer together form a read sensor; and
forming a soft bias layer behind at least a portion of the free layer in an element height direction normal to the media-facing surface, the soft bias layer comprising a soft magnetic material configured to compensate for a magnetic coupling of the free layer with the AP2.

18. The method as recited in claim 17, further comprising forming a hard bias layer, at least a portion thereof being formed behind the soft bias layer in the element height direction, the hard bias layer comprising a hard magnetic material configured to provide unidirectional anisotropy to the soft bias layer.

19. The method as recited in claim 18, wherein at least a portion of the hard bias layer is in direct contact with a back edge of the soft bias layer, and wherein at least a portion of the hard bias layer extends at least to sides of the read sensor and the soft bias layer in a track width direction.

20. The method as recited in claim 17, further comprising forming a side shield on one or more sides of the read sensor in the track width direction, wherein the soft bias layer extends to at least one of: an extent of the side shield on both sides of the read sensor in the track width direction, and beyond a back edge of the read sensor in the element height direction.

21. The method as recited in claim 20, wherein when the soft bias layer extends beyond the back edge of the read sensor in the element height direction, the side shield extends to about an extent of the soft bias layer in the element height direction.

22. The method as recited in claim 17, wherein the soft bias layer has shape anisotropy in a direction perpendicular to the media-facing surface of the read sensor by forming the soft bias layer to have a length in the element height direction which is at least twice a width in a track width direction to form the shape anisotropy, and wherein the width of the soft bias layer is greater than or equal to a width of the read sensor in the track width direction.

23. The method as recited in claim 17, wherein the AP1 extends below the AP2 and the soft bias layer in the element height direction, and wherein at least a portion of the AP2 extends below the soft bias layer in the element height direction.

24. The method as recited in claim 17, further comprising:
forming a spacer layer above the free layer and the soft bias layer in the first direction;
forming an upper shield above the spacer layer in the first direction; and
forming an insulating layer between the soft bias layer and all of: the barrier layer, the free layer, and the AP2.

25. The method as recited in claim 17, wherein a material, thickness, and/or height of the soft bias layer is adjusted at a back edge of the free layer to compensate for the magnetic coupling of the free layer with the AP2, the back edge being an edge of the free layer opposite the media-facing surface of the free layer.
